(19) United States
(12) Patent Application Publication
(10) Pub. No.: US 2017/0017479 A1
(43) Pub. Date: Jan. 19, 2017

(54) METHOD FOR UPDATING AND/OR UPGRADING THE OPERATING SOFTWARE OF AN ELECTRONIC DEVICE

(71) Applicant: Fresenius Medical Care Deutschland GmbH, Bad Homburg (DE)

(72) Inventors: Frank HEDMANN, Volkach (DE); Torsten HOCHREIN, Knetgau (DE)

(73) Assignee: Fresenius Medical Care Deutschland GmbH, Bad Homburg (DE)

(21) Appl. No.: 15/101,560

(22) PCT Filed: Dec. 3, 2014
(86) PCT No.: PCT/EP2014/003228

§ 371 Date: Jun. 3, 2016

(30) Foreign Application Priority Data
Dec. 10, 2013 (DE) 102013021158.1

(51) Int. Cl. G06F 9/445; G06F 21/31

(52) U.S. Cl. CPC G06F 8/65; G06F 21/31

(57) ABSTRACT

The invention relates to a method for updating and/or upgrading the operating software of an electronic device, particularly a medical device, by means of a user authentication means, particularly a user authentication card, having an integrated memory, which user authentication means a user feeds to the device before the use of the device typical of operation in order to authenticate the user on the device. During the authentication process, one or more software packages are transferred from the user authentication means to the device in order to update and/or upgrade the operating software. The invention further relates to an electronic device, preferably a medical device, especially preferably a dialysis machine, comprising a reading device for reading out a user authentication means, particularly a user authentication card, and means for checking if the device operating software can be updated and/or upgraded by means of one or more software packages stored on a user authentication means that can be inserted into the reading device.

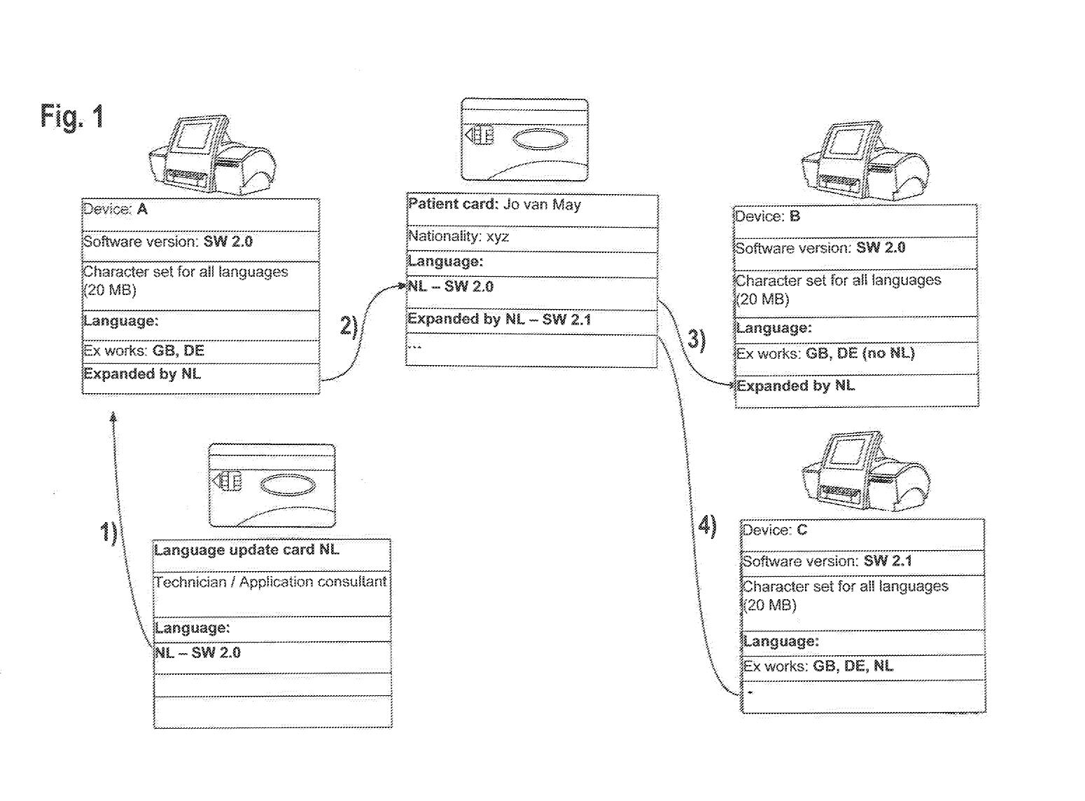

The invention relates to a method of updating and/or upgrading the operating software of an electronic device, in particular of a medical device, having a user authentication means with an integrated memory, in particular a user authentication card, which a user supplies to the device before the customary use of the device to authenticate himself at the device.

The required operating system of an electronic device is called the operating software. In addition to the management of the device hardware and the control of the device functions, the operating software offers a series of interfaces, in particular for interactive user inputs. An input field and a display element of the device are typically available for this purpose.

Information for interactive user inputs are presented visually or aurally on the device in the language set ex works. If the operating software comprises a plurality of language packs, the user can choose between different language presentations. To keep the ex-works manufacturing costs and the memory requirements low, such electronic devices are only equipped with one language pack or with a limited number of language packs. If the device is to be delivered to a foreign country or if the user desires a language not initially available, the operating software has to be expanded to include the required language packs by means of a software upgrade.

The upgrade process typically takes place by a trained technician. This upgrade process is, however, complex and/or expensive and has to be carried out manually for every single device.

The aforesaid problems apply in particular to medical devices, in particular to dialyzers. The operating software installed on the device side controls the dialysis process for the patient treatment, on the one hand, and, on the other hand, provides an interactive menu navigation for the user-side configuration of the dialyzer. It is particularly desirable for medical devices that the patient can determine his preferred language presentation for the machine operation. Dialyzers at a vacation destination can be named as practical examples which should be provided for a plurality of tourists from the most varied countries. These devices then have to comprise a huge number of different language packs.

Since the delivery of dialyzers typically takes place with a limited number of language packs for cost reasons, the desired language packs must be installed later by complex and/or expensive software upgrades under certain circumstances. The same applies to the case if already installed language packs are to be updated to a newer version.

The object of the present invention deals with simplifying a corresponding update process or upgrade process for an electronic device.

This object is achieved by a method in accordance with the features of claim 1. Advantageous embodiments of the method are the subject of the subordinate claims 2-8 dependent on the main claim.

In accordance with claim 1 a method is proposed for updating and/or upgrading the operating software of an electronic device, in particular of a medical device. The method in accordance with the invention is to be used with electronic devices in which the operator has to authenticate himself using a separate user authentication means suitable for this purpose, in particular using a user authentication card, before the customary use of the device. The method can preferably be used with medical devices, for example with dialyzers, in particular for peritoneal dialysis or hemodialysis. Other purposes of use are possible with devices for flight passenger check-in at airports or on automated teller machines. The user authentication means in this case would be a corresponding flight passenger card of an airline, a credit card, a drivers license, an ID card or a bank card or ATM card.

The user authentication cards can generally be any desired chip cards, frequently also called smart cards or integrated circuit cards. Such cards have at least one installed integrated circuit with memory means, optionally with additional hardware logic and/or a programmable microprocessor. The reading of these cards at the device side takes place by card readers provided for this purpose at the electronic device. The invention should, however, not be restricted to the use of user authentication cards, In principle, any form of authentication means with an integrated memory for the storing of one or more software packs is suitable for carrying out the method.

The method in accordance with the invention makes use of the fact that an authentication process takes place by means of a user authentication means prior to the putting into operation of the device by the user. In accordance with the invention, it is now proposed that one or more software packs are transferred by the user authentication means to the device to update and/or upgrade the device operating software during the authentication process.

In contrast to the prior art, no special update process by a trained technician is therefore necessary; the update/upgrade process is rather carried out in the background during everyday use of the device. Update packs are stored in advance in the memory of the authentication means of the user and are transferred to the electronic device during the customary operational use of the electronic devices for upgrading or updating the operating software.

The update process is in particular to be understood such that already existing software packs of the operating software are replaced with a more current version stored in the user authentication means. The upgrade process is in turn to be understood such that the existing operating software of the electronic device is to be complemented by additional functions or data packs. The present version of the operating software is not thereby updated, but rather only expanded by additional functions.

Provision can be made in a preferred embodiment that a check is made at the device side prior to the update or upgrade whether the one or the plurality of software packs is/are already present at the device. A transfer of the one or more software packs by the user authentication means to the electronic device is only carried out for the case that the software packs to be transferred are not present on the electronic device or are only present in an older version.

It is of advantage if a check is made at the device side during the authentication process whether one or more software packs already installed or stored at the device side are stored in the user authentication means. If corresponding software packs are not present in the user authentication means, they are preferably transferred to the user authentication means.

This procedure is in particular meaningful when users register or could register on different electronic devices using their user authentication means, Software packs of an electronic device can be forwarded to a plurality of further electronic devices without additional effort via the user authentication means using the proposed procedure, i.e. by means of his user authentication means, the user distributes one or more software packs of one electronic device to further devices which do not yet have or have not yet installed this software pack or these software packs.

It is particularly preferred if one or more user-specific parameters are stored in the user authentication means, It is expedient in this connection if the transfer of the one or more software packs by the authentication means to the electronic device takes place in dependence on the one or more stored user-specific parameters. The user-specific parameters ideally comprise a type of user profile which characterizes the user behavior or preferences of the user; for example whether he has already used specific software packs in the past or whether he will use them in the future with sufficient probability. Against this background, an update or an expansion of an electronic device can only be carried out when the respective owner of the user authentication means has also actually used the software packs to be copied in the past or will use them with high probability in the future.

Equally, the transfer of the one or more software packs by the electronic device to the user authentication means can likewise take place in dependence on the one or more user-specific parameters. The forwarding of the software packs is namely only meaningful when they are possibly meaningful for the owner of the user authentication means or could play a role in the close future.

The user authentication means can store any desired further data in addition to these parameters, in particular user data for authentication and device-specific data which are required for the device operation and configure the device for the user.

Alternatively or additionally, it is likewise possible to carry out the transfer from the user authentication means to the device in dependence on a preceding user entry. It is conceivable that a corresponding acknowledgement is required by the user, that is by the owner of the authentication means. Provision can equally be made that the transfer of a corresponding software pack only takes place when the user requests or would like to start a corresponding software pack at the electronic device via a user input.

The proposed method in accordance with the invention is in particular suitable for a use with medical devices, in particular with a dialyzer. Such medical devices are equipped with means for user authentication so that a patient to be treated can use a corresponding patient card to register at the dialysis device. Corresponding patient cards have treatment data which the dialysis device configures in accordance with the specifications of the user or with the treatment laid down. In addition to these treatment data, the patient card can additionally contain language preference data which are evaluated by the electronic device and automatically switch the device menu navigation into the desired language.

In this connection, one or more software packs can represent language packs which are required for a visual and/or aural menu navigation in the respective language on the electronic device and which can be installed retroactively as required. It is conceivable in this case that a patient registers with his patient card at a dialyzer which has previously not provided a corresponding language pack for a menu navigation in the patient's desired language. However, the corresponding language pack can be stored on the patient card so that dialyzer is automatically expanded by the desired language pack by the process in accordance with the invention.

It is likewise possible in this connection that a patient purchases a dialysis machine which is already equipped with a suitable language pack for the language of the menu navigation desired by him. This language pack is automatically copied onto his patient card during the first application process. The patient can thus register at a further dialyzer without the preinstalled language version and then automatically expand it by the desired language.

In addition to the method in accordance with the invention, the present invention relates to an electronic device, preferably to a medical device, particularly preferably to a dialyzer, having a reader for reading a user authentication means, in particular in the form of a user authentication card, as well as having means for checking whether the device operating software can be updated or upgraded with one or more software packs stored on a user authentication means which can be read by the reader, as well as optionally having means for transferring one or more software packs stored on the user authentication means to the device.

The electronic device furthermore preferably comprises means for carrying out the method in accordance with the invention or an advantageous embodiment of the method in accordance with the invention. The electronic device obviously has the same advantages and properties as the method in accordance with the invention so that a repetitive description will be dispensed with at this point.

In addition to the electronic device, the present invention moreover relates to a user authentication means or to a user authentication card, in particular to a patient card, having a memory means for storing one or more software packs and having means for carrying out the method of the invention in accordance with the present invention.

Further advantages and properties of the invention will be explained in more detail in the following with reference to an embodiment shown in the only drawing,

The only FIGURE shows a practical scenario with a total of three medical devices A, B, C for illustrating the method in accordance with the invention. The devices A, B, C shown can be dialyzers, in particular for peritoneal dialysis or hemodialysis.

Each device is equipped with corresponding operating software, with the two devices A, B being equipped with the software version SW 2.0, while the device C already runs on a later software version SW 2.1.

The device A was delivered ex works with the two language packs GB, DE for the English and German languages. This means that a patient who registers with a patient card 10 at the device A can select either the English language or alternatively the German language for the interactive menu navigation.

If the device A is to be expanded by a further language pack, for example by a menu display in the Dutch language, it was previously customary that a technician carries out an upgrade at the device A using a language update card provided specifically for this purpose and post-installs the Dutch language pack matching the installed software version of the device A. This expansion step carried out by a technician or by an application consultant is marked by the reference numeral 1. Subsequently, the device A is thus expanded to include the additional language pack NL in the Version NL-SW 2.0 for the operating software SW 2.0.

Care must be taken in this respect that the version of the language pack has to be identical to the version of the device software as different versions are not compatible with one another.

Each device A, B, C has a reader for receiving a corresponding patient card. The patient card can be designed in the form of a chip card or smart card, with information on the patient being stored in the integrated memory. This includes, for example, personal data such as the patient's name and his nationality. The patient card furthermore includes treatment-relative data which automatically carry out corresponding configuration settings on the reading in the medical device A, B, C and program the device for the treatment of the authenticated patient.

The medical device A, B, C can moreover automatically determine the preferred menu language of the patient and automatically switch the menu display to the preferred menu language using the nationality stored on the patient card. If the patient registers at medical device A using the patient card, the menu will be displayed in accordance with his language preference, for example in the Dutch language. The matching language pack necessarily has to be present in the version compatible with the device software for the switch, which is the case in the present case after the preceding update process 1.

At the same time, a check is, however, made at the device A whether the language pack preferred by the patient is stored in the internal memory of the patient card. If this is not the case, the device A initiates a download of the language pack NL in the version 2.0 to the memory of the patient card, as is marked by reference numeral 2.

At a following time, for example during a vacation stay in a foreign country, the patient registers at the medical device B available there using his patient card. The ex-works installation of the language pack (NL) preferred by the patient is, however, not provided for the vacation country. The patient can, however, provide the required language update himself by the method in accordance with the invention. In detail, the device B checks the nationality of the patient during the authentication and determines the preferred menu language from this. If the preferred language pack NL is not currently present on the device, the patient card is searched for the corresponding language pack. If a matching language pack is present which is moreover compatible with the installed device software of the device B, the download of the language pack is started by the device.

For the case shown, the language pack NL for the software version 2.0 is present on the patient card so that the electronic device B is automatically expanded to include the corresponding language pack. This step is marked by the reference numeral 3. The device language is then automatically switched to the Dutch language.

At a later time, the owner of the patient card registers at the medical device C. The device software of the device C determines during the application process and the reading of the patient card that the preferred language of the patient is Dutch. However, the Dutch language pack NL for the version 2.1 has already been installed ex works on the device C. Since this language version has not yet been stored on the patient card, the pack NL SW 2.1 is automatically transferred to the memory of the patient card (reference numeral 4). The patient card now has both versions 2.0 and 2.1 of the Dutch language pack.

The language update process was previously strictly separate from the regular user operation of the device, i.e. when a patient changes a device, for example travels to a foreign-language country, a device with the correct software version and the correct language always had to be separately available at the vacation location.

With the method in accordance with the invention, the patient can provide the language himself, i.e. if the patient card of the patient is equipped with all secondary versions, the device to be used accordingly can be expanded to include the desired language version. Only one single main device (device A) has to be provided with the main version, said device retroactively equipping the inserted patient card with the desired language pack. The original effort for an update of the languages can be dispensed with for the production, the service and the technician/application consultant.

1. A method for updating and/or upgrading the operating software of an electronic device, in particular of a medical device, having a user authentication means, in par tinder a user authentication card, which has an integrated memory, wherein a user supplies the user authentication means to the device prior to the customary use of the device to authenticate himself at the device,
characterized in that
one or more software packs are transferred to the device by the user authentication means for updating and/or upgrading the operating software during the authentication process,

2. A method in accordance with claim 1, characterized in that a check is made at the device side prior to the update/upgrade whether the one or more software packs of the user authentication means is/are already present at the device side and the transfer only takes place as required.

3. A method in accordance with claim 1, characterized in that a check is made at the device side during the authentication process whether one or more software packs installed or stored at the device side are stored on the user authentication means and in that a transfer of these software packs to the user authentication means takes place if required.

4. A method in accordance with claim 1, characterized in that one or more user-specific parameters are stored on the user authentication means and the transfer of the one or more software packs to the device by the user authentication means and/or the transfer at the device side from the device to the user authentication means takes/take place in dependence on the one or more user-specific parameters.

5. A method in accordance with claim 1, characterized in that a transfer from the user authentication means to the device takes place in dependence on a preceding user input.

6. A method in accordance with claim 1, characterized in that the user authentication means/the user authentication card is a patient card on which treatment data and or language preference data are stored or can be stored on it in addition to the one or more software packs.

7. A method in accordance with claim 1, characterized in that the one or more software packs are language packs which can be installed on the device for a visual and/or aural menu navigation in the respective language.

8. A method in accordance with claim 1, characterized in that a check is made prior to the transfer of the one or more software packs to the device whether the version of the software packs to be transferred is compatible with the version of the device operating software.

9. An electronic device, preferably a medical device, particularly preferably a dialyzer, having a reader for reading a user authentication means, in particular a user authentication card, and having means for checking whether the device operating software can be updated and/or upgraded by one or more software packs stored on a user authentication means which can be inserted into the reader.

10. An electronic device preferably a medical device, particularly preferably a dialyzer, having a reader for reading a user authentication means, in particular a user authentication card, and having means for checking whether the device operating software can be updated and/or upgraded by one or more software packs stored on a user authentication means which can be inserted into the reader, having means for carrying out the method in accordance with claim 1.

11. A user authentication means, in particular a patient card, having a memory means for storing one or more software packs and having means for carrying out the method in accordance with claim 1.
